(19) United States
(12) Patent Application Publication
(10) Pub. No.: US 2026/0365044 A1
(43) Pub. Date: Nov. 19, 2026

(54) VEHICLE HAVING HIGH VOLTAGE BATTERY AUXILIARY EXPANDABLE THERMAL MANAGEMENT POUCH

(71) Applicants: FCA US LLC, Auburn Hills, MI (US); Stellantis Auto SAS, Poissy (FR)

(72) Inventor: Jill M. KOEPFER, Auburn Hills, MI (US)

(21) Appl. No.: 19/206,140

(22) Filed: May 13, 2025

(51) Int. Cl. B60L 50/64; H01M 10/613; H01M 10/625; H01M 10/6556; H01M 10/6568; H01M 10/667

(52) U.S. Cl. CPC B60L 50/64; H01M 10/613; H01M 10/625; H01M 10/6556; H01M 10/6568; H01M 10/667; B60L 2240/545

(57) ABSTRACT

A battery pack thermal management system that can include a coolant inlet line; a plurality of heat sinks configured to receive a coolant from the coolant inlet line and transfer heat generated by a plurality of battery cells and at least one high voltage component to the coolant; a coolant outlet line configured to receive the coolant from the plurality of heat sinks; and at least one auxiliary thermal management pouch provided between the housing and at least one of the plurality of battery cells and the at least one high voltage component, wherein the at least one auxiliary thermal management pouch includes an inlet port in communication with the coolant inlet line and an outlet port in communication with the coolant outlet line, and the at least one auxiliary thermal management pouch is flexible and configured to expand after receipt of the coolant from the coolant inlet line.

### FIELD

The present disclosure relates to a vehicle having a high voltage battery auxiliary expandable thermal management pouch.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. Thermal runaway may be initiated by a temperature of the battery cells reaching a critical temperature. Accordingly, vehicles that include these types of battery cells may sometimes include a battery thermal management system that can provide cooling to the battery cells located in the battery pack.

Battery thermal management systems are designed to cool the battery cells. It should be noted, however, that battery packs may include other high voltage components in addition to the battery cells that may also require cooling. Due to packaging restraints, often times these high voltage components can be located in areas of the battery pack that do not have access to various features of the battery thermal management system such as a cold plate that carries a coolant. It is desirable, therefore, to provide a thermal management system that can provide cooling to the battery cells of the battery pack as well as other high voltage components that may be provided in the battery pack.

### SUMMARY

This section provides a general summary of the disclosure, and is not a comprehensive disclosure of its full scope or all of its features.

According to a first aspect of the present disclosure, there is provided a vehicle that may include a battery pack having a housing that encases a plurality of battery cells and at least one high voltage component; and a thermal management system provided in the housing. The thermal management system can include a coolant inlet line; a plurality of heat sinks configured to receive a coolant from the coolant inlet line and transfer heat generated by the plurality of battery cells and at least one high voltage component to the coolant; a coolant outlet line configured to receive the coolant from the plurality of heat sinks; and at least one auxiliary thermal management pouch provided between the housing and at least one of the plurality of battery cells and the at least one high voltage component, wherein the at least one auxiliary thermal management pouch includes an inlet port in communication with the coolant inlet line and an outlet port in communication with the coolant outlet line, and the at least one auxiliary thermal management pouch is flexible and configured to expand after receipt of the coolant from the coolant inlet line.

According to the first aspect, the at least one auxiliary thermal management pouch is positioned proximate and configured to provide cooling to the at least one high voltage component.

According to the first aspect, the at least one auxiliary thermal management pouch is positioned proximate and configured to provide cooling to the plurality of battery cells.

According to the first aspect, the battery pack includes a pair of the auxiliary thermal management pouches, a first of the pair of auxiliary thermal management pouches being positioned proximate and configured to provide cooling to the at least one high voltage component and a second of the pair of auxiliary thermal management pouches being positioned proximate and configured to provide cooling to the plurality of battery cells.

According to the first aspect, the at least one auxiliary thermal management pouch is positioned on a side of the at least one high voltage components that is opposite to a side of the at least one high voltage component that faces a respective heat sink of the plurality of heat sinks.

According to the first aspect, the at least one auxiliary thermal management pouch is positioned on a side of the plurality of battery cells that is opposite to sides of the plurality of battery cells that face a respective heat sink of the plurality of heat sinks.

According to the first aspect, the at least one auxiliary thermal management pouch is formed of a flexible polymeric material.

According to the first aspect, the at least one auxiliary thermal management pouch includes a plurality of corrugations that permit the at least one auxiliary thermal management pouch to expand, contract, and be oriented in different directions.

According to the first aspect, the vehicle can include at least one temperature sensor located in the housing that is configured to generate a signal indicative of a temperature within the housing.

According to the first aspect, the vehicle can include a controller in communication with the at least one temperature sensor that is configured to receive and analyze the signal indicative of the temperature within the housing.

According to the first aspect, the at least one auxiliary thermal management pouch includes a conduit that extends between the inlet port and the coolant inlet line, and a valve that is configured to be controlled by the controller controls a flow of coolant from the coolant inlet line to the inlet port through the conduit.

According to the first aspect, based on the signal indicative of a temperature within the housing analyzed by the controller, the controller is configured to open the valve and permit the flow of coolant from the coolant inlet line to the inlet port.

According to a second aspect of the present disclosure, there is provided a vehicle that may include a battery pack having a housing that encases a plurality of battery cells and at least one high voltage component, the housing including a cover and a tray; and a thermal management system provided in the housing. The thermal management system can include a coolant inlet line; a plurality of heat sinks provided in the tray configured to receive a coolant from the coolant inlet line and transfer heat generated by the plurality of battery cells to the coolant; a coolant outlet line configured to receive the coolant from the plurality of heat sinks; a cold plate provided between the plurality of battery cells and the at least one high voltage component, the cold plate configured to receive the coolant from the coolant inlet line and transfer heat generated by the at least one high voltage component to the coolant, and the cold plate configured to direct the coolant to the coolant outlet line; a first auxiliary thermal management pouch provided between the cover and the plurality of battery cells; and a second auxiliary thermal management pouch provided the cover and the at least one high voltage component, wherein the first and second auxiliary thermal management pouches each include an inlet port in communication with the coolant inlet line and an outlet port in communication with the coolant outlet line, and the first and second auxiliary thermal management pouches are each flexible and configured to expand after receipt of the coolant from the coolant inlet line.

According to the second aspect, the first auxiliary thermal management pouch is positioned on a side of the plurality of battery cells that is opposite to sides of the plurality of battery cells that face the plurality of heat sinks.

According to the second aspect, the second thermal management pouch is positioned on a side of the at least one high voltage components that is opposite to a side of the at least one high voltage component that faces the cold plate.

According to the second aspect, the first and second auxiliary thermal management pouches are each formed of a flexible polymeric material.

According to the second aspect, the first and second auxiliary thermal management pouches each include a plurality of corrugations that permit the first and second auxiliary thermal management pouches to expand, contract, and be oriented in different directions.

According to the second aspect, the vehicle can include at least one temperature sensor located in the housing that is configured to generate a signal indicative of a temperature within the housing.

According to the second aspect, the vehicle can include a controller in communication with the at least one temperature sensor that is configured to receive and analyze the signal indicative of the temperature within the housing.

According to the second aspect, the first and second auxiliary thermal management pouches each include a conduit that extends between the inlet port and the coolant inlet line, and a valve that is configured to be controlled by the controller controls a flow of coolant from the coolant inlet line to the inlet port through the conduit.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an example vehicle having a battery and high voltage component thermal management system according to a principle of the present disclosure;

FIG. 2 is an isometric perspective view of an example battery pack that may be used in the vehicle illustrated in FIG. 1;

FIG. 3 is an isometric perspective view of the example battery pack illustrated in FIG. 2, with the battery pack cover removed;

FIG. 4 is an isometric perspective view of the example battery pack illustrated in FIG. 2, with the battery pack cover, battery cells, and high voltage components removed;

FIG. 5 is an isometric perspective view of the battery and high voltage component thermal management system that may be used in the example battery pack illustrated in FIGS. 2-4;

FIG. 6 is a schematic representation of a battery pack having the battery and high voltage component thermal management system illustrated in FIG. 5, wherein the thermal management system additional includes at least one expandable coolant pouch to provide additional cooling to either the battery cells or high voltage components of the battery pack according to a principle of the present invention; and

FIGS. 7-9 are perspective views of example expandable coolant pouches according to a principle of the present invention.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

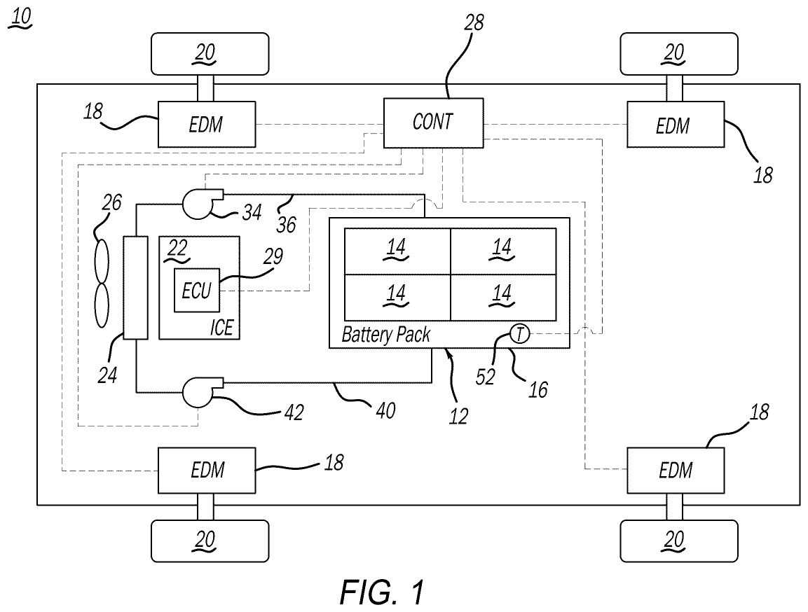

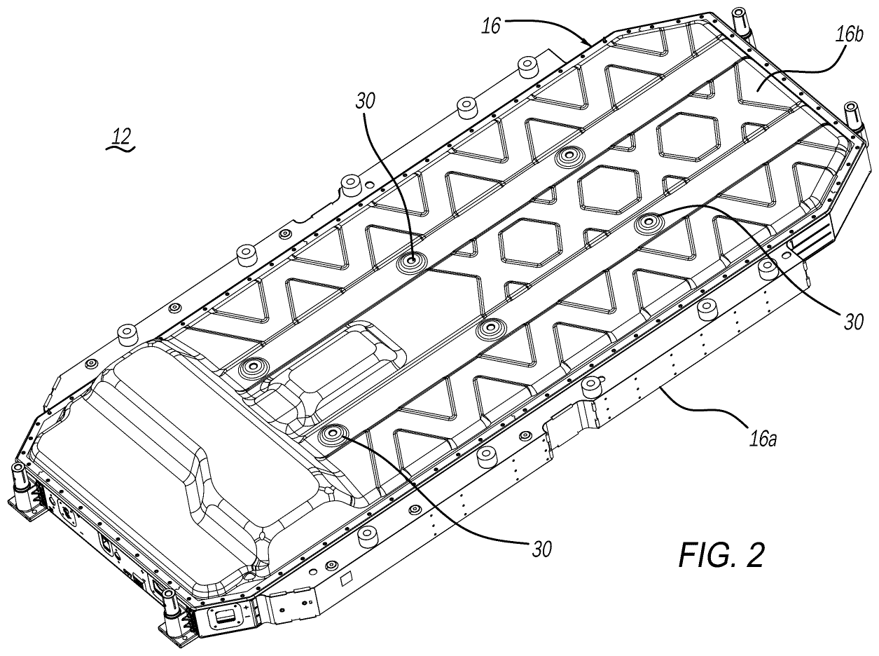

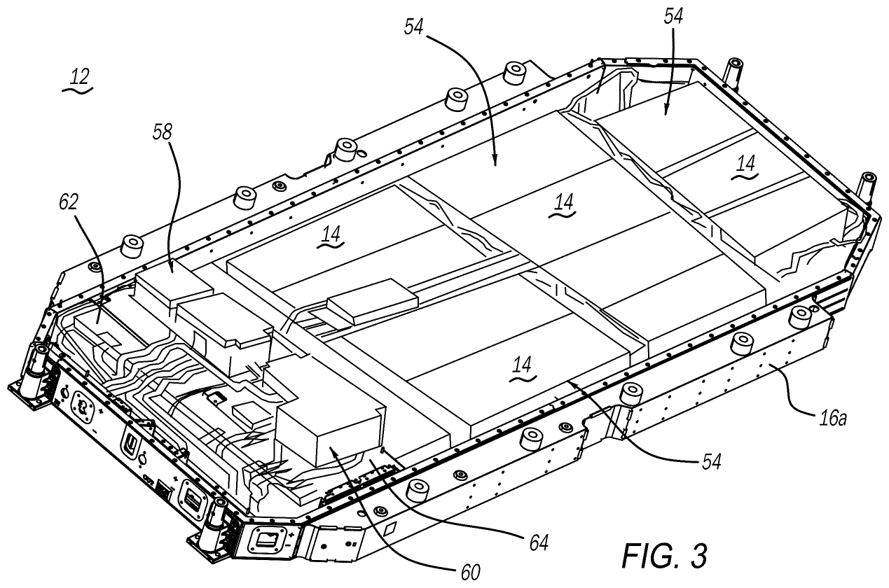

FIG. 1 is a schematic representation of a vehicle 10 according to a principle of the present disclosure. In the illustrated embodiment, vehicle 10 may be an electrically powered vehicle including a battery pack 12 that includes a plurality of battery cells 14. Example battery cells 14 include lithium-ion battery cells, lithium-metal battery cells, and combinations thereof. It should be understood, however, that other types of battery cells 14 known to one skilled in the art may be used, without limitation. Battery pack 12 includes a housing 16 having a tray 16a and cover 16b (see, e.g., FIG. 2) that encases each of the battery cells 14. Tray 16a and cover 16b are each preferably formed of a rigid metal material (e.g., steel, aluminum, and the like) that is resistant to puncture and is non-flammable. An example battery pack 12 is illustrated in FIGS. 2 and 3.

Still referring to FIG. 1, a plurality of electric drive modules 18 are illustrated that electrically actuate each wheel 20 of vehicle 10. While four electric drive modules 18 are illustrated, it should be understood that vehicle 10 may include only a pair of electric drive modules 18, or include only a single electric drive module 18. For example, the front wheels 20 of vehicle 10 may be driven by one electric drive module 18, while the rear wheels 20 may be driven by another electric drive module 18. Alternatively, a single electric drive module 18 can be used to drive the pair of front wheels 20 or the pair of rear wheels 20. Regardless of the configuration selected, it should be understood that electric drive modules 18 receive a voltage or current from battery pack 12 that is utilized by the electric drive modules 18 to drive the wheels 20 of the vehicle 10.

While not required, it should also be understood that vehicle 10 may also include an internal combustion engine (ICE) 22 such that vehicle 10 may be a hybrid electric vehicle. In the event that vehicle 10 is a hybrid electric vehicle including ICE 22, a tailpipe (not shown) for carrying exhaust gases generated by ICE 22 may be connected to ICE 22. Vehicle 10 may also include a heat exchanger or radiator 24 and fan 26 for cooling ICE 22 during operation thereof. Vehicle 10 may include a controller 28 that may communicate with battery pack 12, electric drive module(s) 18, and an electronic control unit (ECU) 29 of ICE 20. If vehicle 10 does not include ICE 22, the heat exchanger 24 may be a chiller.

As noted above, battery cells 14 may sometimes undergo a process called thermal runaway during failure conditions of the battery cell(s) 14. Thermal runaway may result in a rapid increase of battery cell temperature accompanied by the release of various gases. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 12 increases, the pressure within battery pack 12 also increases. Housing 16 of battery pack 12, therefore, includes a plurality of vents 30, which are best shown in FIG. 2, that permit the pressure and gases to escape housing 16. Vents 30 may each include a valve (not shown) that may be a one-way valve and opens upon a predetermine pressure threshold being generated within housing 16. For example, if the pressure within housing 16 reaches 100 millibars the valves may open and permit the gases within housing 16 to exit the battery pack 12 through vents 30. Alternatively, the valves may be electrically operated (e.g., solenoid) valves that communicate with and can be operated by controller 28.

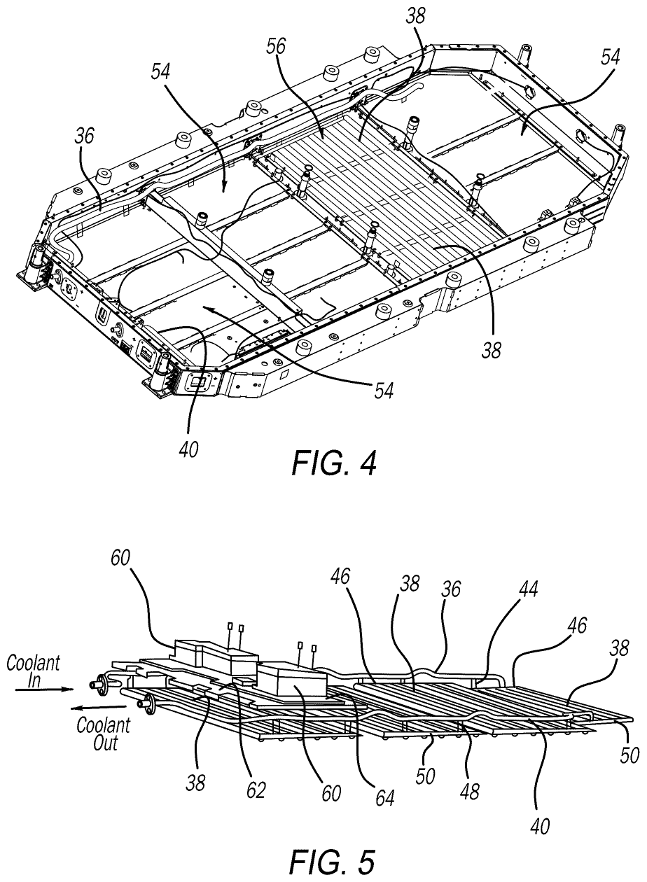

Heat exchanger 24 carries a coolant that can be used to cool battery pack 12 and potentially avoid battery cells 14 from reaching a critical temperature that may lead to thermal runaway. In the illustrated embodiment, the coolant, which may be a mixture of water and glycol, may be drawn to battery pack 12 by a first pump 34 through an inlet line 36. After entering housing 16, coolant can pass through heat sinks 38 (FIGS. 4-6) in thermal contact with battery cells 14 that draw heat away from battery cells 14 to be exchanged with the coolant such that the coolant will absorb heat generated by batteries 14 before exiting housing 16 through an outlet line 40. Coolant in outlet line 40 can be drawn back to heat exchanger 24 by a second pump 42 where the coolant can exchange the heat absorbed from the batteries 14 with the ambient air passing through heat exchanger 24 that is drawn by fan 26 until the process starts again.

FIG. 5 illustrates an example arrangement of the inlet line 36, heat sinks 38, and outlet line 40 within tray 16a (not shown in FIG. 5) of battery pack 12. Put another way, FIG. 5 illustrates an example battery thermal management system 35. As can be seen in FIG. 4, inlet line 36 may extend along a length of battery pack 12 and includes a plurality of inlet branches 44 that respectively feed coolant from inlet line 26 to a plurality of inlet manifolds 46. Similarly, outlet line 40 may extend along the length of battery pack 12 and includes a plurality of outlet branches 48 that respectively receive coolant from a plurality of outlet manifolds 50. Inlet manifolds 46 and outlet manifolds 50 are each in communication with a plurality of heat sinks 38.

Coolant carried by inlet line 36 flows from inlet line 36 into inlet branches 44, then flows from inlet branches 44 into inlet manifolds 46, and then flows from inlet manifolds 46 into the plurality of heat sinks 38 where heat generated by battery cells 14 (not shown in FIG. 4) that lay overtop heat sinks 38 is exchanged with the coolant therein. Coolant that has exchanged heat with battery cells 14 flows from heat sinks 38 into outlet manifolds 50, then flows from outlet manifolds 50 into outlet branches 48, and then flows from outlet branches 48 into outlet line 40, which carries the coolant back to heat exchanger 24 to be cooled by the ambient air drawn by fan 26. As this process repeats, battery cells 14 may be cooled to maintain battery cells 14 beneath a critical temperature that can lead to thermal runaway.

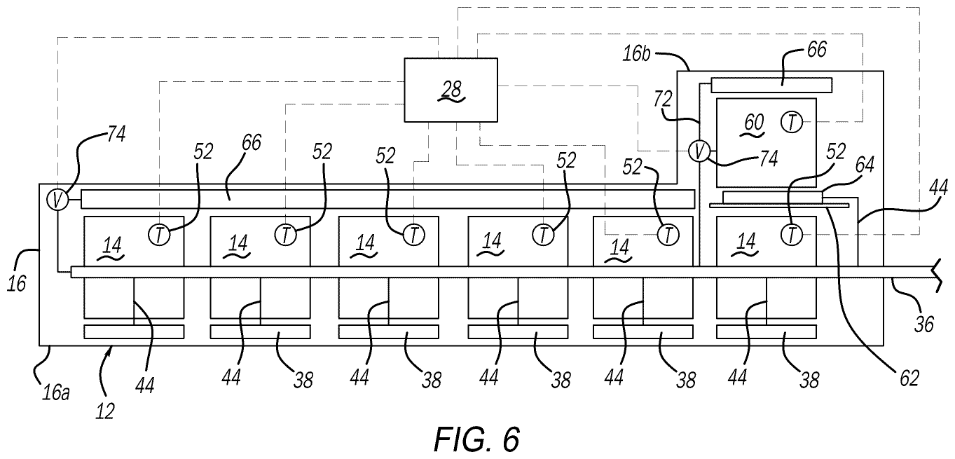

It should be understood that cooling of battery cells 14 may be controlled by controller 28. In this regard, again referring to FIG. 1, it should be understood that battery pack 12 includes at least one temperature sensor 52 in communication with battery pack 12 that generates signals indicative of temperature within battery pack 12. While only a single temperature sensor 52 is illustrated in FIG. 1, it should be understood that a plurality of temperature sensors 52 may be used. For example, as shown in FIG. 6, each battery cell 14 may include a dedicated temperature sensor 52 such that a temperature of each individual battery cell 14 may be monitored and communicated to controller 28.

Controller 28 can adjust an amount of coolant that is circulated through battery thermal management system 35 based on the signal(s) indicative of temperature generated by temperature sensor(s) 52 that are received by controller 28. For example, if controller 28 determines, based on the signals indicative of temperature generated by temperature sensor(s) 52, that battery cells 14 are operating at a temperature that requires increased cooling, controller 28 can instruct pumps 34 and 42 to increase in speed to reduce the amount of time that it takes the coolant to circulate through battery thermal management system 35. Similarly, if controller 28 determines, based on the signals indicative of temperature generated by temperature sensor(s) 52, that battery cells 14 are not operating at a temperature that requires increased cooling, controller 28 may adjust the speed of pumps 34 and 42 accordingly.

Again, referring to FIGS. 4 and 5, it can be seen that housing 16 of battery pack 12 includes a plurality of first sections 54 where battery cells 14 and banks or groups 56 of heat sinks 38 of battery thermal management system 35 are located (FIG. 4). Housing 16 of battery pack 12 also includes at least one second section 58 that contains various high voltage components 60 (FIG. 5), and that sits overtop at least one of the first sections 54 in a manner where the high voltage components 60 are spaced apart from the banks 56 of heat sinks 38 by a panel 62 that lies between the battery cells 14 and the high-voltage components 60.

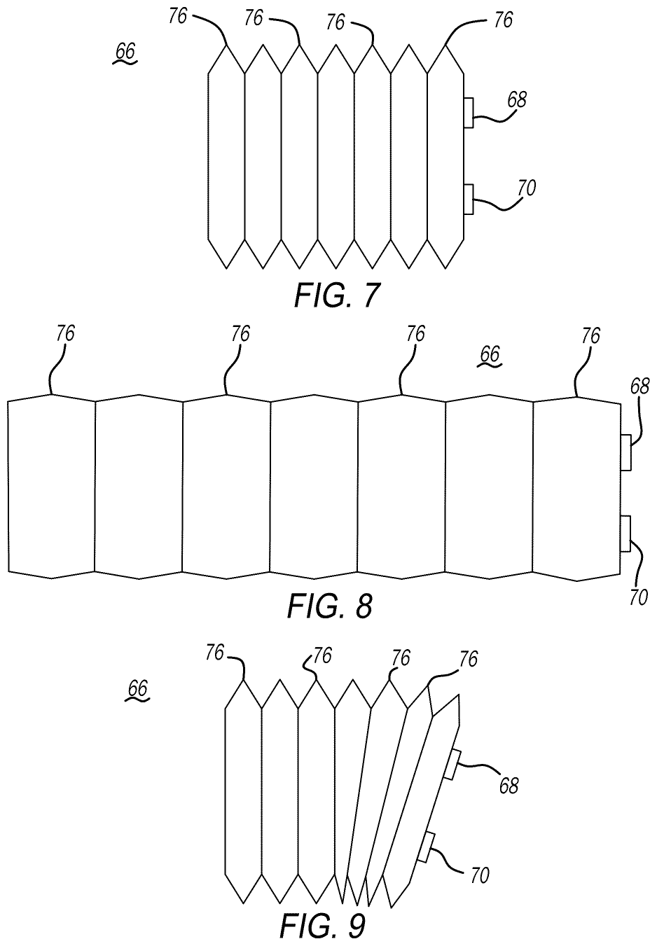

In the illustrated embodiment, the high-voltage components 60 may be cooled by a cold plate 64 that is positioned between high-voltage components 60 and panel 62, and is in fluid communication with inlet line 36 and outlet line 40 of battery thermal management system 35 (FIG. 6). Put another way, cold plate 64 is similar to each of the heat sinks 38 that provide cooling to battery cells 14. It should be understood, however, that the cooling provided by cold plate 64 to high-voltage components 60 and by heat sinks 38 to battery cells 14 only cools the surfaces (i.e., bottom surfaces) of these components that are in contact with cold plate 64 and heat sinks 38, and it may be desirable to provide additional cooling to additional surfaces (e.g., upper surfaces or side surfaces) of these components if necessary. Thus, to provide cooling to high voltage components 58 and/or battery cells 14 of battery pack 12, battery thermal management system 35 may include at least one auxiliary thermal management pouch 66 that is positioned between housing cover 16b and at least one of the high-voltage components 58 and battery cells 14. Example locations for pouch 66 are best shown in FIG. 6, and example pouches 66 are shown in more detail in FIGS. 7-X.

Now referring to FIGS. 7-9, it can be seen that pouch 66 is an expandable pouch or container having an inlet port 68 and an outlet port 70 that may be respectively connected to inlet line 36 and outlet line 40 of battery thermal management system 35 by conduits 72 (FIG. 6), which may be flexible hoses. FIG. 7 illustrates pouch 66 in a non-expanded state; FIG. 8 illustrates pouch 66 in a fully expanded state; and FIG. 9 illustrates how pouch 66 may flex to in various directions to be accommodated in tight spaces that may be present between battery cells 14 and/or high voltage components 60 and housing cover 16b of battery pack 12.

That is, because pouch 66 is flexible and expandable, pouch 66 may be positioned in a location where there will be a gap between the housing cover 16b and high voltage components 58 and/or battery cells 14 in a non-expanded state (i.e., a state of not including any coolant from battery thermal management system 35), then the flexible conduits 72 can be fluidly attached to the inlet line 36 and outlet line 40 of the battery thermal management system 35, and then the housing cover 16b may be reattached to housing tray 16a. Then, when battery thermal management system 35 is in use and fluid flows through the flexible conduits 72 into an interior of pouch 66, the pouch 66 can expand due to the fluid and flowing through pouch 66 to provide intimate contact between pouch 66 and the components that require cooling.

Although not required, it should be understood that at least one of the flexible conduits 72 (e.g., the conduit 72 connected to inlet port 68) may include a valve 74 in communication controller 28 to selectively control when pouch 66 is inflated with coolant. Again, as noted above, temperature sensor(s) 52 can be used to determine a temperature of battery cells 14 and high voltage components 60. Based on signals indicative of temperature communicated by temperature sensor(s) 52 to controller 28, controller 28 can determine whether battery cells 14 and/or high voltage components 60 require additional cooling. If additional cooling is required that would not be sufficiently provided by increasing a speed of pumps 34 and 42 to increase fluid flow through heat sinks 38 and cold plate 64 of thermal management system 35, controller 28 can instruct valves 74 to open and provide coolant to pouches 66 to additionally cool battery cells 14 and/or high voltage components 60.

Pouch 66 may be formed of a flexible material such as a polymeric material that is fluid-tight and resistant to puncture. Example polymeric materials include polyamide (e.g., NYLON®) and para-aramid (e.g., KEVLAR®). Again, referring to FIGS. 7-9, pouch 66 may have an accordion-like structure including a plurality of corrugations 76 that permit pouch 66 to expand, contract, and flex in various directions to be accommodated in the narrow gaps or spaces that may be present between housing 16, battery cells 14, and high-voltage components 60.

Lastly, it should be understood that pouch 66 can be used to retrofit to existing battery packs that may not necessarily provide the adequate cooling desired to battery cells 14 and high voltage components 60. Again, as noted above, conduits 72 may be flexible hoses. Conduits 72, therefore, can have variable lengths and be directed and attached to the existing battery thermal management system architecture including, for example, attaching the conduits 72 to inlet line 36, outline 40, or to the inlet and outlet manifolds 46 and 50. When existing battery packs are retrofit to include a pouch 66 and conduits 72, the conduits 72 may not necessarily include a valve 74.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery pack having a housing that encases a plurality of battery cells and at least one high voltage component; and
a thermal management system provided in the housing, the thermal management system including:
a coolant inlet line;
a plurality of heat sinks configured to receive a coolant from the coolant inlet line and transfer heat generated by the plurality of battery cells and at least one high voltage component to the coolant;
a coolant outlet line configured to receive the coolant from the plurality of heat sinks; and
at least one auxiliary thermal management pouch provided between the housing and at least one of the plurality of battery cells and the at least one high voltage component,
wherein the at least one auxiliary thermal management pouch includes an inlet port in communication with the coolant inlet line and an outlet port in communication with the coolant outlet line, and
the at least one auxiliary thermal management pouch is flexible and configured to expand after receipt of the coolant from the coolant inlet line.

2. The vehicle according to claim 1, wherein the at least one auxiliary thermal management pouch is positioned proximate and configured to provide cooling to the at least one high voltage component.

3. The vehicle according to claim 1, wherein the at least one auxiliary thermal management pouch is positioned proximate and configured to provide cooling to the plurality of battery cells.

4. The vehicle according to claim 1, wherein the battery pack includes a pair of the auxiliary thermal management pouches, a first of the pair of auxiliary thermal management pouches being positioned proximate and configured to provide cooling to the at least one high voltage component and a second of the pair of auxiliary thermal management pouches being positioned proximate and configured to provide cooling to the plurality of battery cells.

5. The vehicle according to claim 2, wherein the at least one auxiliary thermal management pouch is positioned on a side of the at least one high voltage components that is opposite to a side of the at least one high voltage component that faces a respective heat sink of the plurality of heat sinks.

6. The vehicle according to claim 2, wherein the at least one auxiliary thermal management pouch is positioned on a side of the plurality of battery cells that is opposite to sides of the plurality of battery cells that face a respective heat sink of the plurality of heat sinks.

7. The vehicle according to claim 1, wherein the at least one auxiliary thermal management pouch is formed of a flexible polymeric material.

8. The vehicle according to claim 1, wherein the at least one auxiliary thermal management pouch includes a plurality of corrugations that permit the at least one auxiliary thermal management pouch to expand, contract, and be oriented in different directions.

9. The vehicle according to claim 1, further comprising at least one temperature sensor located in the housing that is configured to generate a signal indicative of a temperature within the housing.

10. The vehicle according to claim 9, further comprising a controller in communication with the at least one temperature sensor that is configured to receive and analyze the signal indicative of the temperature within the housing.

11. The vehicle according to claim 10, wherein the at least one auxiliary thermal management pouch includes a conduit that extends between the inlet port and the coolant inlet line, and a valve that is configured to be controlled by the controller controls a flow of coolant from the coolant inlet line to the inlet port through the conduit.

12. The vehicle according to claim 11, wherein based on the signal indicative of a temperature within the housing analyzed by the controller, the controller is configured to open the valve and permit the flow of coolant from the coolant inlet line to the inlet port.

13. A vehicle comprising:
a battery pack having a housing that encases a plurality of battery cells and at least one high voltage component, the housing including a cover and a tray; and
a thermal management system provided in the housing, the thermal management system including:
a coolant inlet line;
a plurality of heat sinks provided in the tray configured to receive a coolant from the coolant inlet line and transfer heat generated by the plurality of battery cells to the coolant;
a coolant outlet line configured to receive the coolant from the plurality of heat sinks;
a cold plate provided between the plurality of battery cells and the at least one high voltage component, the cold plate configured to receive the coolant from the coolant inlet line and transfer heat generated by the at least one high voltage component to the coolant, and the cold plate configured to direct the coolant to the coolant outlet line;
a first auxiliary thermal management pouch provided between the cover and the plurality of battery cells; and
a second auxiliary thermal management pouch provided the cover and the at least one high voltage component,
wherein the first and second auxiliary thermal management pouches each include an inlet port in communication with the coolant inlet line and an outlet port in communication with the coolant outlet line, and
the first and second auxiliary thermal management pouches are each flexible and configured to expand after receipt of the coolant from the coolant inlet line.

14. The vehicle according to claim 13, wherein the first auxiliary thermal management pouch is positioned on a side of the plurality of battery cells that is opposite to sides of the plurality of battery cells that face the plurality of heat sinks.

15. The vehicle according to claim 13, wherein the second thermal management pouch is positioned on a side of the at least one high voltage components that is opposite to a side of the at least one high voltage component that faces the cold plate.

16. The vehicle according to claim 13, wherein the first and second auxiliary thermal management pouches are each formed of a flexible polymeric material.

17. The vehicle according to claim 16, wherein the first and second auxiliary thermal management pouches each include a plurality of corrugations that permit the first and second auxiliary thermal management pouches to expand, contract, and be oriented in different directions.

18. The vehicle according to claim 13, further comprising at least one temperature sensor located in the housing that is configured to generate a signal indicative of a temperature within the housing.

19. The vehicle according to claim 18, further comprising a controller in communication with the at least one temperature sensor that is configured to receive and analyze the signal indicative of the temperature within the housing.

20. The vehicle according to claim 10, wherein the first and second auxiliary thermal management pouches each include a conduit that extends between the inlet port and the coolant inlet line, and a valve that is configured to be controlled by the controller controls a flow of coolant from the coolant inlet line to the inlet port through the conduit.
